(19) United States
(12) Patent Application Publication
(10) Pub. No.: US 2018/0231773 A1
(43) Pub. Date: Aug. 16, 2018

(54) DISPLAY SYSTEM FOR A WINDSHIELD AND METHOD FOR CONFIGURING THE DISPLAY SYSTEM

(71) Applicant: VISTEON GLOBAL TECHNOLOGIES, INC., Van Buren Township, MI (US)

(72) Inventors: Giang-Nam Nguyen, Karlsruhe (DE); Yanning Zhao, Monheim (DE); Patrick Nebout, Saint-Cloud (FR)

(21) Appl. No.: 15/892,755

(22) Filed: Feb. 9, 2018

(30) Foreign Application Priority Data
Feb. 10, 2017 (DE) 10 2017 102 704.1

(51) Int. Cl. G02B 27/01; G02F 1/29; B60K 35/00

(52) U.S. Cl. CPC G02B 27/0101; G02B 27/0103; B60K 2350/2052; B60K 35/00; B60K 2350/921; G02F 1/29

(57) ABSTRACT

A display system for a windshield of a vehicle comprises a projection device configured to generate an image upon a projection surface and a controller for processing information related to the image. Furthermore, the display device is configured with a recording device which is pointed toward the projection surface and connected to the controller by a first data channel. The projection surface is configurable and likewise connected by means of a second data channel to the controller. The projection surface may include a light-transparent liquid crystal display and/or a flexible liquid crystal display, and may be configured as a mirror or as a diffuser for showing the image as a hologram. A method for configuring the display system is also provided.

### CROSS REFERENCE TO RELATED APPLICATION

This U.S. utility patent application claims the benefit of German patent application DE 10 2017 102 704.1, filed Feb. 10, 2017, the contents of which are incorporated herein by reference in its entirety.

### BACKGROUND

It is known from the prior art how to project information into the visual field of a driver, such as the driver or an automobile or a pilot, by a head-up display. A head-up display, also called HUD for short, is a display system in which the user can maintain the posture of his head or his viewing direction substantially in the original orientation for viewing the displayed information.

Such head-up displays generally comprise an image-producing unit, which provides the information being represented in the form of an image, an optical module, which allows the beams to travel inside the head-up display as far as an exit opening and which is also called the mirror optics, and a projection surface for representing the image being generated. The optical module conveys the image to the projection surface, which is formed as a reflective, light-transparent windshield and which is also called a combiner. The driver of the vehicle sees the reflected information of the image-generating unit and at the same time the actual surroundings behind the windshield. In this way, the driver's attention, especially when driving a motor vehicle, is directed at happenings in front of the vehicle, while be can discern the information projected into his visual field. HUD systems enhance the safety of driving the vehicle. In head-up displays one often distinguishes between virtual images and real images,

EP 0 286 962 A2 describes a laser projector, with which an image generated on a projection screen is projected onto a frequency-dependent mirror on a windshield so that the driver gets a virtual image seemingly in the visual range in front of the windshield. Furthermore, the possibility is disclosed of representing an image, generated with a laser projector, in the region of the windshield by means of a holographic optical element which is arranged on the windshield or in the vicinity of the windshield. The errors arising due to the curvature of the windshield are to be compensated by an appropriately designed optics, which is done by polished lenses or mirrors. Curved mirrors can also be used here.

With HUD systems it is desirable on the one hand for the user to have a good visual field and on the other hand for the extra display to have a good image quality with sufficient image brightness, good contrast, and high resolution, as well as minimum distortion and minimum image errors. In the past, various possibilities were pointed out for increasing the image quality. Among the factors which worsen the image quality are, for example, so-called speckles or image distortions.

Speckles are produced by unevenness of an illuminated surface, each unevenness constituting a scattering center from which spherical waves emanate, interfering in turn with spherical waves of other scattering centers in the far field. The pattern is basically random, since the surfaces used in HUD systems usually have no systematic structures. Speckles need to be suppressed in order to provide a clear image within a HUD system.

DE 10 2013 008 372 A1 discloses a method in which an identical image is reflected repeatedly, one after another in time succession, on a projection surface. The individual images are distinguished from one another by the variation of the position of the object being represented in the light modulator, known as the SLM (Spatial Light Modulator) for short, by their position on the projection surface. Due to the position differences of the individual images, the interference conditions are disrupted on average and thus speckle is reduced or prevented.

According to WO 2016 072 372 A1, speckle is minimized by suitably adapted lenses or lens arrangements.

What the developments of the prior art have in common is that the elements of the particular display systems for windshields, especially mirror reflecting surfaces and diffracting optical elements, need to be specially adapted and designed for each model series of a means of transportation. This adaptation is very tedious and thus cost-intensive. Especially on account of the small number of means of transportation of each individual model series, the manufacture of a small lot size of HUD systems is also very cost-intensive. Also when the windshield is replaced the representation might be greatly impaired, so that the system needs to be adapted once more.

There exists a need for a display system for a windshield which can be manufactured economically yet still meets the high demands on image quality.

Furthermore, there exists a need to provide a method by which the quality of the images generated within a HUD system can be increased in simple manner.

### SUMMARY

A display system for a windshield of a vehicle, such as a car, truck, airplane, or any other means of transportation with a windshield is provided. The display system provides for the user to maintain the posture of his or her head and to maintain a viewing direction. Furthermore, the disclosure relates to a method for configuring the display system.

The display system comprises a projection device, a projection surface and a controller. The controller may fulfill other control functions beyond those related to the functions of the display system for a windshield, such as those regarding the content of a projected image.

According to an aspect of the disclosure, the display system includes a recording device, which is pointed toward the projection surface. The recording device may be, for example, a camera, which is adapted in its resolution to the corresponding requirements. Information registered by the recording device is taken by a first data channel to the controller. Parameters are also stored in the controller, such as those pertaining to the elements of the HUD system.

The projection surface is configurable such that different diffraction patterns can be defined. In coordination with the results of the recording, the recording device can make changes to the diffraction pattern which are then sent to the projection surface and which can be used there as the basis for the reproduction of the image for an observer. For the transmittal of new diffraction patterns, the projection surface is likewise connected by a second data channel to the controller.

The data channels are preferably configured in the form of a cable, but other forms of data transmittal are conceivable, such as by Bluetooth, infrared, or radio.

According to a first alternative embodiment, the projection surface is formed as a transparent liquid crystal display, disposed proximate to, or in the region of, the windshield. With a liquid crystal display, known as a LCD for short, any given contents can be represented by changing the orientation of the liquid crystals.

HUD systems often constitute transparent projection surfaces which are folded down or moved into the visual field of the user, without hindering the forward view of the user in the viewing direction. A recording device may then be arranged so that it scans and relays for example the transparent image surface out of sight of the user or the objects represented thereon. Virtual images can be provided with the HUD system being described.

According to a second alternative embodiment, the projection surface is a flexible liquid crystal display disposed on the windshield. It is an advantage that the independently produced element can easily be designed by the method described below, thanks to the improvement by the recording device, and also be produced economically as a result of larger manufacturing lots.

For a further virtual representation of images, the projection surface of the display system for a windshield may have a mirror reflecting design. As soon as an image is projected onto the projection field or the projection surface, the observer receives the impression that the represented object is situated in space in the viewing direction behind the windshield.

A further advantageous embodiment includes the projection surface configured as a diffuser, so that improved quality holographic representations can also be reproduced.

The data obtained with the recording device can be stored by a photopolymer and saved for when it is needed. The stored data may be compared by a computer to an ideal and used for improving the display system. The stored data, for example, may be used for a calibration in event of a changing of components of the HUD system.

A method for configuring a display system for a windshield is also provided. First, an image is generated on a projection surface by a projection device, the projection surface having an expected diffraction pattern. After this, the image is registered by a recording device and sent to a controller. Within the controller, the image is compared to a desired quality of the representation. Next, an improved diffraction pattern is generated to improve the representation by a projection surface and transmitted to the projection surface for the configuring of the projection surface. This does away with costly computations of the individual parts of the system, since an image is created first on the basis of an estimated diffraction pattern and then serves as the computational basis for an adaptation of the projection surface, so that the same components can always be used regardless of the type of the transportation or the model series, although each is adapted in its quality.

The method for configuring a display system for a windshield can also use the expected diffraction pattern as the image, especially in regard to the computing power of the controller. The diffraction pattern is advantageously saved as a gray scale image and can be quickly compared against the recording. For the representation of the expected diffraction pattern in this case, the phase of each beam of light is adapted depending on the gray value of each pixel of the liquid crystal display, so that a diffraction pattern can be registered by the recording device.

The comparison carried out inside the controller results in an improvement which is relayed to the projection surface. After this, an improved image can be reproduced on the projection surface, which can be configured as an element of a HUD system, such as a diffractive optical element (DOE) or holographic optical element (HOE). The DOE serves to form of a beam of light, often a laser beam. The physical principle is based on diffraction by a grating. The HOE is used to represent a holographic image.

According to one modification, the method for configuring a display system for a windshield is repeated one time or multiple times to enhance the image quality. For example, especially high quality can be produced for an image by iteration or generically by other mathematical algorithms.

According to preferred embodiment of the method for configuring a display system for a windshield, the improved diffraction pattern is stored so that it can be retrieved when needed. In particular, the manufacturing of a HOE can thus be avoided, which results in lower costs. The improved diffraction pattern is preferably stored by a photopolymer. Consequently, the generally known advantages of photopolymers can be employed.

### BRIEF DESCRIPTION OF THE DRAWINGS

Further details, features and advantages of designs of the invention result from the following description of embodiment examples in reference to the associated drawings.

FIG. 1 is a diagram of a display system for a windshield with a transparent liquid crystal display acting as a diffuser;

FIG. 2 is a diagram of a display system for a windshield with a reflective liquid crystal display; and

FIG. 3 is a diagram of a display system for a windshield with a reflective liquid crystal display acting as a diffuser.

### DETAILED DESCRIPTION

Recurring features are marked with identical reference numerals in the figures.

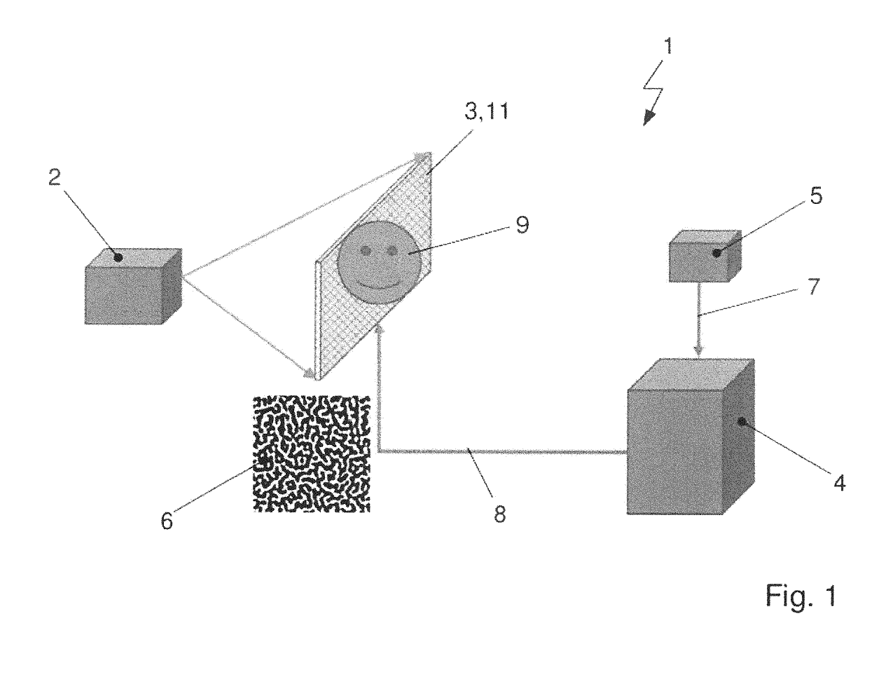

FIG. 1 shows an arrangement of a display system 1 for a windshield, having a projection device 2, a projection surface 3, especially a projection screen 11, and a controller 4. A recording device 5 is pointed at the projection surface 3 and is designed to register images 9 projected onto the projection surface 3. The registered images are sent from the recording device 5 to the controller 4 by a first data channel 7.

The controller 4 computes an improved diffraction pattern 6, which in turn is transmitted from the controller 4 by means of a second data channel 8 to the projection surface 3 for further use. With the use of the improved diffraction pattern 6, losses in image quality caused by the projection surface 3 can be compensated.

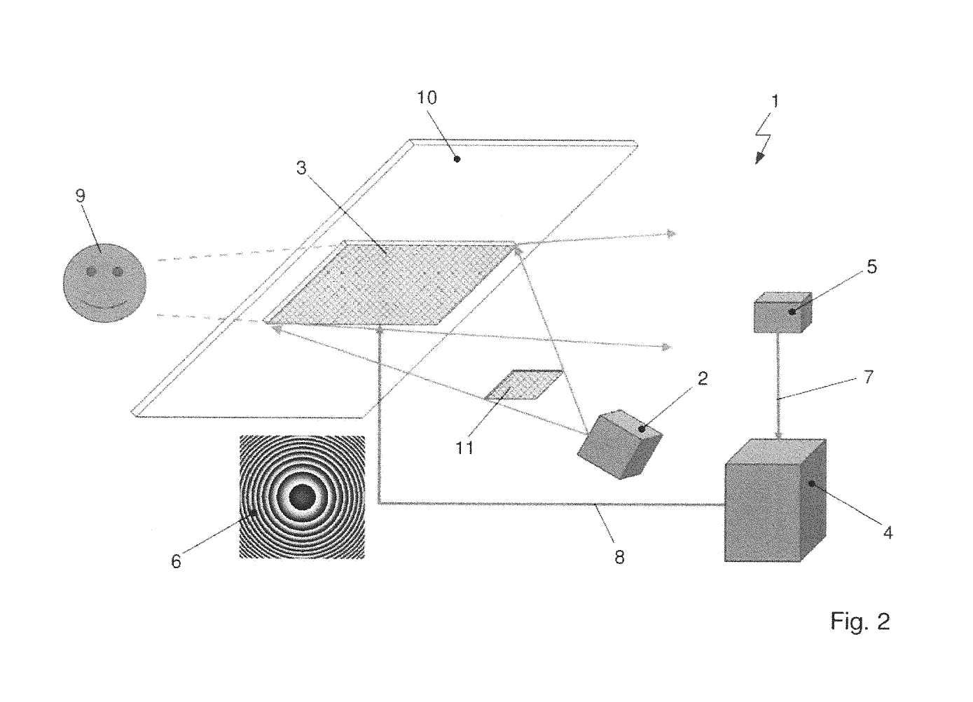

FIG. 2 shows an arrangement of the display systems 1 for a windshield in which the projection surface 3 is arranged on a windshield 10. By a projection device 2, an image 9 is transmitted through a transparent projection screen 11 of an HOE onto the projection surface 3, constituting the reflecting part of an HOE. The recording device 5 is aimed at the projection surface 3 and receives the image 9, which appears virtually behind the windshield 10 out of sight of an observer. The recording is transmitted by the recording device 5 by means of the first data channel 7 to the controller 4 and evaluated within the controller 4.

The computed improved diffraction pattern 6 is then relayed by means of the second data channel 8 to the projection surface 3 for further use.

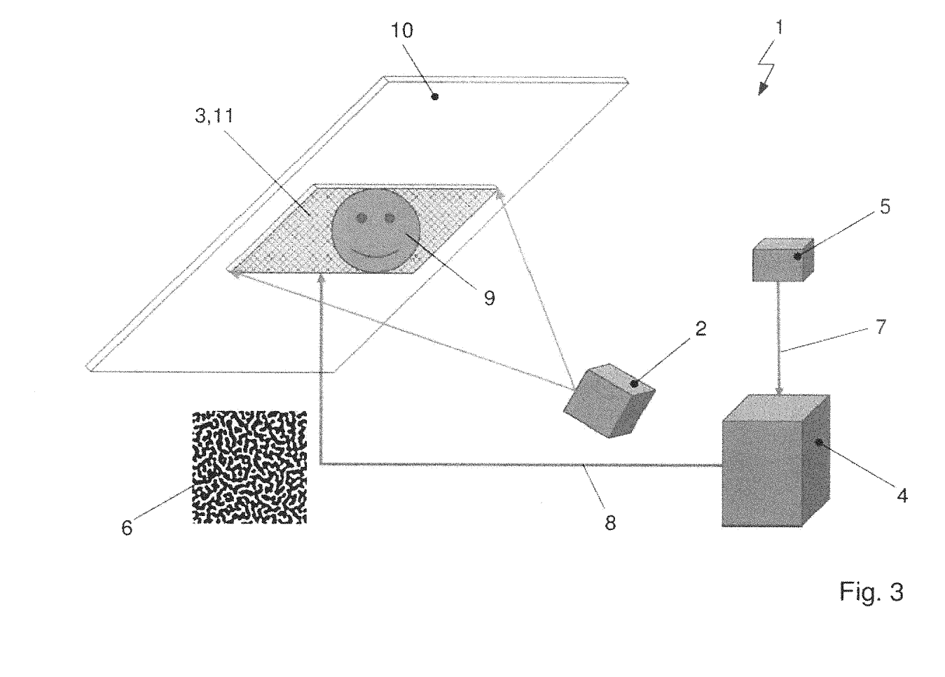

The display system 1 for a windshield can furthermore be used as well for the representation of a holographic image, according to FIG. 3. For this, a projection device 2 projects an image 9 onto a projection surface 3, which is arranged on a windshield 10. The recording device 5 in order to receive the image 9 is aimed at the projection surface 3, especially a projection screen 11. The image 9 received is transmitted by means of the first data channel 7 to the controller 4 and checked for the desired quality. After an improvement, the improved diffraction pattern 6 is relayed by means of the second data channel 8 to the projection surface 3, designed as a diffuser, and used to enhance the quality of further representations.

Since the preceding display systems described in detail are sample embodiments, they may be modified as usual by the person skilled in the art to a broad degree, without leaving the scope of the invention. In particular, the specific embodiments of the projection surfaces may also have a form other than described here. Likewise, the recording device may be designed in a different form when such is required to enhance the quality. Moreover, the use of the indefinite article “a” or “an” does not rule out the respective features also being present in the plural.

What is claimed is:

1. A display system for a windshield, comprising:
a projection device configured to generate an image upon a projection surface;
a controller for processing information related to the image;
a recording device pointed toward the projection surface and connected to the controller by a first data channel; and
wherein the projection surface is configurable and connected by a second data channel to the controller.

2. The display system as set forth in claim 1, wherein the projection surface includes a light-transparent liquid crystal display disposed proximate to the windshield.

3. The display system as set forth in claim 1, wherein the projection surface is includes a flexible liquid crystal display disposed on the windshield.

4. The display system as set forth in claim 3, wherein the projection surface is configured as a mirror.

5. The display system as set forth in claim 3, wherein the projection surface is configured as a diffuser.

6. The display system as set forth in claim 1, further including a photopolymer capable of storing an improved diffraction pattern.

7. A method for configuring a display system for a windshield, comprising:
generating an image by a projection device on a projection surface, the projection surface having an expected diffraction pattern,
registering the image by a recording device and transmitting it to a controller,
comparing the image against a desired quality of representation by the controller,
generating an improved diffraction pattern to improve the representation by the projection surface and
configuring the projection surface using the improved diffraction pattern.

8. The method as set forth in claim 7, wherein the image corresponds to the expected diffraction pattern.

9. The method as set forth in claim 7, wherein the steps are repeated multiple times.

10. The method as set forth in claim 7, further including the step of storing the improved diffraction pattern.

11. The method as set forth in claim 10, Wherein the improved diffraction pattern is stored by a photopolymer.
